(19) United States
(12) Patent Application Publication
(10) Pub. No.: US 2010/0036882 A1
(43) Pub. Date: Feb. 11, 2010

(54) SARPS MANAGEMENT AND IMPLEMENTATION SYSTEM

(75) Inventors: Sang Ho Chung, Seoul (KR); Jae Gil Choi, Seoul (KR); Man Heui Chang, Seoul (KR); Hye Jeong Kang, Seoul (KR); Gu Seul Kim, Seoul (KR)

Correspondence Address: CANTOR COLBURN, LLP, 20 Church Street, 22nd Floor, Hartford, CT, 06103, US

(73) Assignee: Republic of Korea(Administration Department; The Ministry Construction and Transporation Civill, Seoul (KR)

(21) Appl. No.: 12/519,235

(22) PCT Filed: Dec. 15, 2006
(86) PCT No.: PCT/KR2006/005492

§ 371 Date: Jul. 31, 2009

(30) Foreign Application Priority Data
Dec. 15, 2006 (KR) 10-2006-0128372

(51) Int. Cl. G06F 17/30

(52) U.S. Cl. 707/104.1; 707/E17.044

(57) ABSTRACT

The present invention relates to a SMIS system for managing systematically an implementation status of an aviation safety regulation, and more particularly, to a SMIS system for analyzing, complementing and assessing automatically an implementation status of an aviation safety regulation in own country on the basis of standards and recommended practices prescribed in the annexes for 18 fields published and managed by the International Civil Aviation.

### TECHNICAL FIELD

The present invention relates to an “international standard and recommended practice management and implementation system (hereinafter ‘SMIS system’)” for managing systematically an implementation status of an aviation safety regulation, and more particularly, to a SMIS system for analyzing, complementing and assessing automatically an implementation status of an aviation safety regulation in own country on the basis of “standards and recommended practices (hereinafter ‘SARPs’)” prescribed in the annexes for 18 fields published and managed by the International Civil Aviation Organization.

### BACKGROUND ART

The International Civil Aviation Organization (hereinafter “ICAO”) is the international cooperation organization devoted to assure the safe, orderly and economic development of the civil air transportation society. The ICAO was founded on the basis of the International Civil Aviation Treaty (Chicago Treaty) signed by the representatives of 52 nations on 1944 in Chicago, U.S.A. and becomes the special organization within the Economic and Social Council of the United Nation in 1947. The ICAO is devoted to a security of a development and safety of the international civil air transportation, a realization of effective and economical transportation and a development of design of aircraft and an aerial navigation. And, the major affairs of The ICAO are to study for a standardization and unification the technology aspect such as the aircraft, the flight attendant, the communication, the airport facilities and the navigation and to provide the member nation with a result of the study. The ICAO controls and inspects whether all the member nations including Republic of Korea implement the aviation safety regulation or not, and the standards and recommended practices consisting of Annexes for 18 fields are utilized as the assessment reference during the control and inspection.

To prepare for an assessment of the control and the inspection as described above, in most of the member nations including Republic of Korea, an actual condition of implementation of the aviation safety regulation is analyzed by a manual operation and the complementary measures are taken against the inadequacies. However, the above management method has several problems as follows:

First, although new aviation safety regulation is examined several times on the basis of a given circumstance of own country from a time on which the regulation is initially proposed to a time on which the final requirement is decided, the above process is carried out by a manual operation, and so too much time and man power should be required for inquiring an opinion and deciding an intension through an investigation of the related data. This process is done by State Letter issued by ICAO.

Second, the time required for dealing with the affair from an initiation of the implementation affair for satisfying each aviation safety regulation to a completion of the affair is frequently elongated more than one year, and so a management omission caused by the human error is generated.

Third, due to a characteristic of the manual operation, it is impossible to identify rapidly and correctly the actual condition. In order to verify and assess the complementation status of own country at a specific point in time, the processes of collecting a corresponding status data from the related department, synthesizing the collected data and then assessing the data are performed. However, a reliability of the results of the above procedure becomes lower.

Fourth, when the modified requirements are generated due to a revision of the aviation safety regulation, an ability to cope with the revision is insufficient. In a case where a requirement of the specific aviation safety regulation is modified or an aviation statue of own country is revised, it is very difficult to verify the relationship among the aviation safety regulations more than 10,000 and several thousands of the articles of the domestic aviation statues corresponding to the aviation safety regulations, and so too much time and effort are required for analyzing to take an appropriate measure.

### DISCLOSURE

### Technical Problem

Accordingly, the present invention is conceived to solve the above problem of the prior art as described above, an object of the present invention is to provide an SMIS system which verifies a responsiveness between the aviation safety regulation of The ICAO and the aviation statute in own country for implementing the aviation safety regulation of the ICAO and manages automatically an implementation status for complementing the responsiveness in real-time to maximize an efficiency of the affair for analyzing and implementing the international standard.

### Technical Solution

In order to achieve the above object, the SMIS system of the present invention comprises a database server including a state letter database (1) consisting of the information on state letters regarding a proposal for enacting/revising the SARPs, a safety regulation database (2) consisting of the information on the SARPs, an aviation statute database (3) consisting of the information on the aviation statute of own country, a comparison/analysis database (4) consisting of the comparison/analysis information on the aviation statute of own country and the SARPs, and an implementation management database (5) consisting of the information on the implementation status; a main server (20) including a comparison/management program (6) connected to the database server (10) and comparing/analyzing the information of the safety regulation database (2) and the information of the aviation statute database (3) and arranging/processing the comparing and analyzing results and then updating the results to the comparison/analysis database (4) and an analysis/report/assessment program (7) providing the information processed by the comparison/management program (6) and receiving the information on an implementation status to update the information to the implementation management database (5); and a terminal (30) connected to the main server via a cable network or a wireless network to transfer the information on the implementation status to the main server (20) and retrieving, lookuping, amending, saving or deleting the information stored in the database server (10) through the main server (20).

At this time, the state letter database (1) comprises the information including a title, a number, an issue date, a distribution date, an essential content, an item indicating whether the state letter issued previously is existed or not and the number of the related annex.

In addition, the safety regulation database (2) comprises the information including the number of annex, the latest revised information, the number of regulation, a content of the regulation and an item indicating whether the duty is implemented or not.

Furthermore, the aviation statute database (3) comprises the information including a title of the statute, the number of the statute, a date on which the statute is enacted/revised, the number of the enacted/revised statute, the number of each article of the statute and a detailed content of the article.

Also, the comparison/analysis database (4) comprises the information classified into five (5) items of “Excellence” indicating “More exacting or exceeds”, “Similarity” indicating “Different in character or other means of compliance”, “Insufficiency” indicating “Less protective or partially compliance”, “Not implemented” indicating “Insufficient at all” and ““Not applicable” indicating that “Not applied to own country”.

In addition, the implementation management database (5) comprises the information including a department in charge, a person in charge, a date on which a completion of the measure is requested, an acting plan, a reason for delaying and a display showing a termination of acting plan. At this time, it is preferred that the information on the person in charge is classified into the information of a staff in charge, an identifier and a deciding officer.

In addition, the end terminal (30) comprises a personal computer, a laptop computer, a personal digital assistant, a cellular phone and a private terminal.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a view showing one embodiment of a structure of a database for an SMIS system according to the present invention;

FIG. 2 is a view showing one embodiment of a structure of the SMIS system according to the present invention;

FIG. 3 is a conceptual view illustrating a task analysis in the SMIS system according to the present invention;

FIG. 4 is a view for comparing between procedures of task using or not using the SMIS system according to the present invention;

FIG. 5 is a view showing an example of the matrix for verifying an implementation status of the international regulation; and

FIG. 6, FIG. 7 and FIG. 8 are views showing operation examples of the analysis/report/assessment program.

### DETAILED DESCRIPTION OF MAIN ELEMENTS

1: state letter database
2: safety regulation database
3: aviation statute database
4: comparison/analysis database
5: implementation management database
6: comparison/management program
7: analysis/report/assessment program
10: database server
20: main server
30: terminal

### BEST MODE

Hereinafter, the embodiments of the present invention will be described in detail with reference to accompanying drawings.

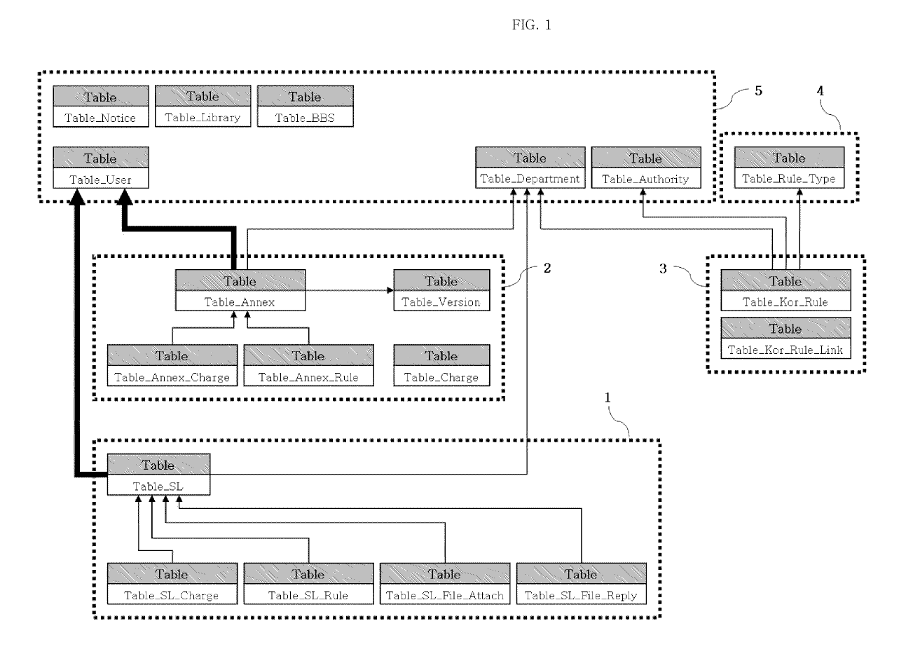

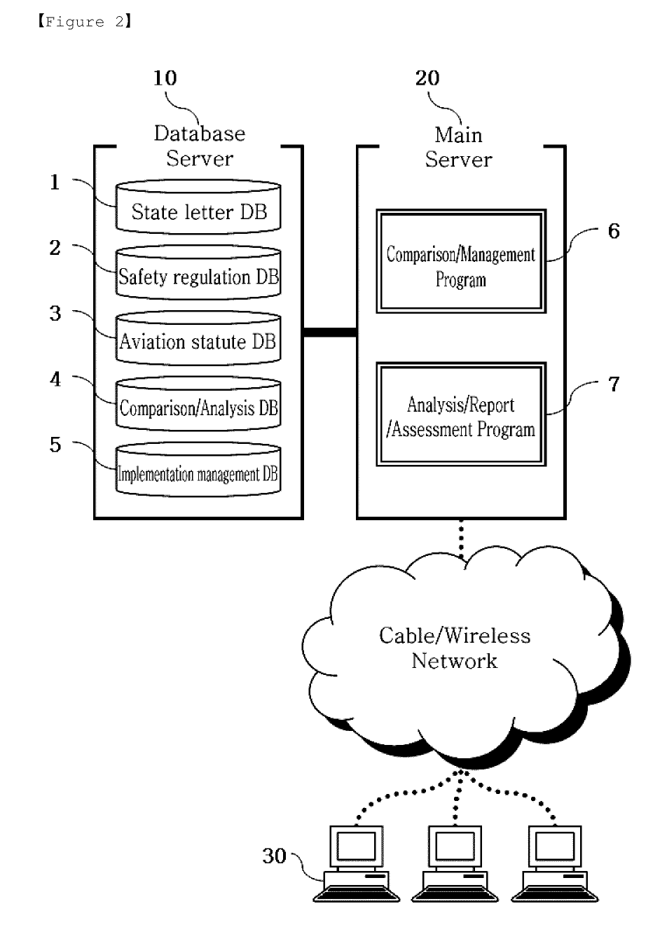

FIG. 1 is a view schematically showing one embodiment of a structure of databases for the SMIS system according to the present invention. The databases for the SMIS system of according of to the present invention comprises a state letter database (1) consisting of a content of the state letter regarding a proposal for enacting/revising the SARPs; a safety regulation database (2) consisting of a content of the SARPs; an aviation statute database (3) consisting of a content the aviation statute of own country; a comparison/analysis database (4) consisting of a comparison/analysis content of the aviation statute of own country and the SARPs; and an implementation management database (5) consisting of a content of the implementation status.

The state letter database (1) comprises a content of the state letter regarding a proposal for enacting/revising the SARPs, in more detail, comprises a title, a number, an issue date, a distribution date, an essential content, an item indicating whether the state letter issued previously is existed or not and the number of the related annex. The state letter database (1) can be constructed as shown in FIG. 1, the information as described above is systematically classified and stored in each table of the state letter database (1) as shown in FIG. 1. In the embodiment as shown in FIG. 1, the title, the number, the issue date, the distribution date and the essential content are stored in a table of Table_SL, a department in charge, an official in charge and a schedule for a measure are stored in a table of Table_SL_charge, an item indicating whether the state letter issued previously is existed or not is stored in a table of Table_SL_Rule, a document file received from the ICAO and a document filed with the ICAO are stored in a table of Table_SL_File_Attach and a measure content notified to the ICAO is stored in a table of Table_SL_File_Reply, or the state letter database 1 can be constructed by combining the contents of items stored in the above tables. The database as shown in FIG. 1 is one embodiment for embodying the present invention, the present invention is limited to the structure as shown in FIG. 1 and titles of the tables and the structure can be modified within the range without departing from a scope of the present invention. The above feature is likewise applied to other databases 2, 3, 4 and 5.

The safety regulation database (2) consists of a content of the SARPs, in more detail, comprises the number of annex, the latest revised information, the number of regulation and a content of the regulation. In the embodiment as shown in FIG. 1, the number of annex is stored in a table of Table_Annex, and the latest revised information, the number of regulation and a content of the regulation are stored in a table of Table_Version.

The aviation statute database (3) consists of a content the aviation statute of own country, in more detail, comprises a title of the statute, the number of the statute, a date on which the statute is enacted/revised, the number of the enacted/revised statute, the number of each article of the statute and a detailed content of the article. In the embodiment as shown in FIG. 1, the above contents can be stored as the item contents of a table of Table_Kor_Rule and a table of Table_Kor_Rule_Linke. At this time, FIG. 1 shows the system database according to the embodiment of the present invention to be utilized in Republic of Korea, and so a term of “Kor” indicating Republic of Korea is marked on the table. However, the name of the table may be modified according to a name of the country in which the system database according to the present invention is utilized.

The comparison/analysis database (4) consists of a comparison/analysis content between the SARPs (that is, a content of the safety regulation database (2) and the aviation statute of own country (that is, the aviation statute database 3), in more detail, the comparison/analysis database (4) is constructed to be displayed as one of the following 5 items:

Excellence: More exacting or exceeds

Similarity: Different in character or other means of compliance

Insufficiency: Less protective or partially compliance)

Not implemented: Insufficient at all

Not applicable

In the embodiment as shown in FIG. 1, the comparison/analysis content can be stored as an item content of a table of Table_Annex_Rule.

The implementation management database (5) consists of a content of the implementation status in more detail, comprises a department in charge, a person in charge (it is desirable to classify the person in charge into a staff in charge, an identifier and a deciding officer), a date on which a completion of the measure is requested, an acting plan, a reason for delaying and a display showing a termination of acting plan. In the embodiment as shown in FIG. 1, the department in charge and the person in charge take out the content stored in tables of Table_Department and Table_Authority and store it in a table of Table_Annex_Charge. Also, the date on which a completion of the measure is requested, the measure schedule, the reason for delaying and the display showing a termination of acting plan are stored in a table of Table_Charge.

In addition, the information related to the management of the members who can retrieve, lookup, amend, save or delete the content of the databases is further stored in the implementation management database (5). Such information can comprise an announcement and an item library. In the embodiment as shown in FIG. 1, the announcement and the item library are stored in a table of Table_Notice and a table of Table_Library, respectively, or the contents of items stored in the tables can be combined.

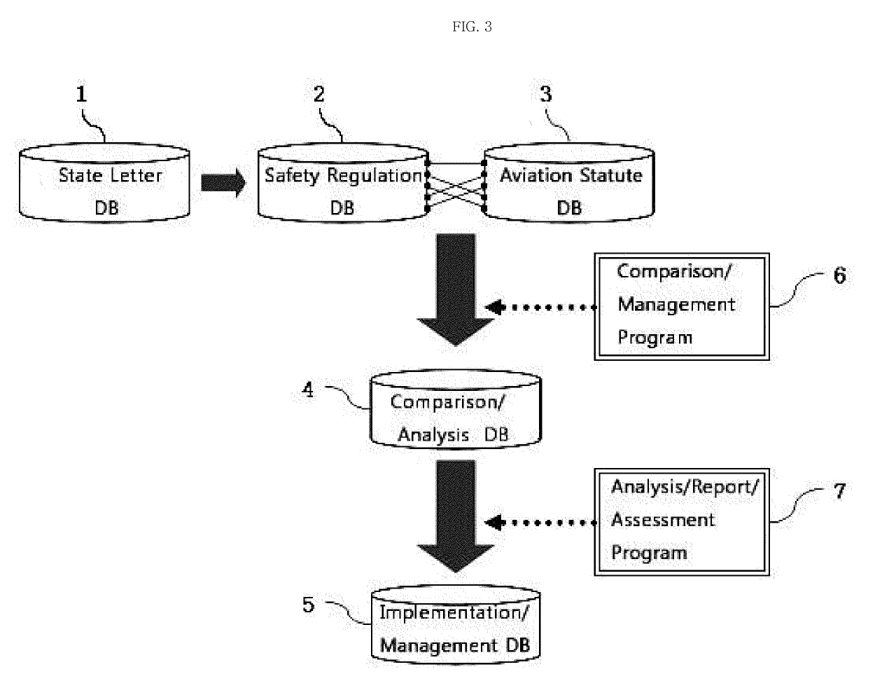

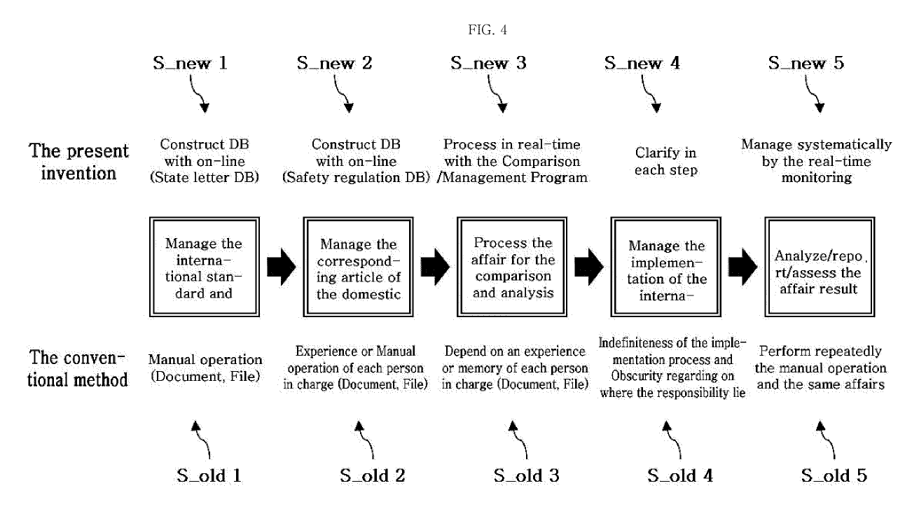

FIG. 2 is a view showing briefly the structure of the SMIS system according to the present invention, and FIG. 3 is a conceptual view illustrating a task analysis in the SMIS system according to the present invention. As shown in the drawings, the SMIS system according to the present invention comprises a database server (10), a main server (20) and a terminal (30). At this time, the database server (10) comprises the state letter database (1), the safety regulation database (2), the aviation statute database (3), the comparison/analysis database (4) and the implementation management database (5).

A comparison/management program (6) and an analysis/report/assessment program (7) are stored in the main server (20) and connected to the database server (10), and so these programs are communicated with each database in the database server (10) and run according to the database. The comparison/management program (6) compares the items of the safety regulation database (2) with the items of the aviation statute database (3) to classify an implementation of the aviation statute of own country against the SARPs into “Excellence”, “Insufficiency”, “Similarity”, “Not implemented” and “Not applicable”. The main server (20) is connected to the terminals (30) via a wireless network or a wired network, and the terminals (30) accesses the database server (10) through the main server (20) to allow the user to verify an implementation status stored in the comparison/analysis database (4) in real-time. In addition, the comparison/management program (6) provides a comparison table between the SARPs and the aviation statute of own country using the result obtained by comparing the items of the safety regulation database (2) with the items of the aviation statute database (3) so that the user can easily lookup the related regulation through the terminal (30) if the item is changed.

Also, the analysis/report/assessment program (7) stored in the main server (20) provides the user (a staff in charge or a manager) with the data with a various forms processed through the comparison/management program (6) to allow the user to verify and assess the implementation status of the SARPs and to take a proper follow-up measure, if necessary. The implementation status is stored in the implementation management database (5) described in the description regarding FIG. 1, The user can access the database server (10) through the main server (20) using the terminal (30) to retrieve, lookup, amend, save or delete each item of the implementation management database (5) according to an authority. As described above, the content of the implementation management database (5) consists of a date on which a completion of the measure is requested, an acting plan, a reason for delaying and a display showing a termination of acting plan, and the implementation status is updated through the terminals (30), and so all the user can verify the implementation status in real-time.

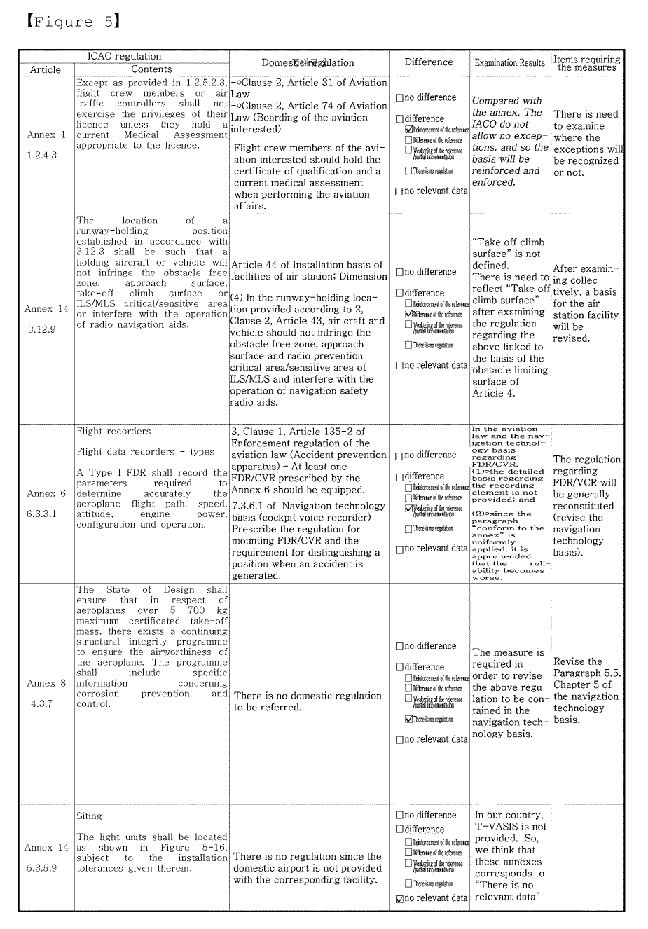

FIG. 4 is a view for comparing between procedures of task using or not using the SMIS system according to the present invention. As shown in the drawing, a procedure of the standard and recommended practice management task can be divided broadly into a step of managing data of the SARPs, a step of managing corresponding articles of the aviation statute of own country, a step of processing a comparing/analyzing task, a step of managing an implementation of the SARPs and a step of analyzing/reporting/assessing the task result.

In general, in the step of managing data of the SARPs, all affairs are carried out by a manual operation S_old1 in which the operator manages the data using documents and files. Also, in the step of managing corresponding articles of the aviation statute of own country, the affairs are carried out by a manual operation S_old2 in which a staff in charge depends on a personal experience and utilizes the documents and the files. In this process, too much man power and time should be required and there will be a strong possibility of generating the mistake. On the other hand, once the SMIS system according to the present invention is utilized, the data of the SARPs is stored on-line in the state letter database 1 (S_new1) and the aviation statute of own country is also stored on-line in the safety regulation database 2 (S-new2), and so the user can easily and rapidly search the correct information at any time without a possibility of generating the mistake after constructing the database.

In addition, in the step of comparing/analyzing the SARPs and the aviation statute of own country, all affairs are generally carried out by a manual operation (S_old3) in which the operator depends on a personal experience or memory and utilizes the documents or the files. Accordingly, there will be a strong possibility of generating the human error due to a wrong memory or a simple mistake in this process. However, once the SMIS system according to the present invention is utilized, the above process is performed in real-time (S_new3) by the comparison/management program, there is no need to compare and analyze the statute which was already compared/analyzed and anyone of the relevant persons in charge can receive easily and rapidly the corrected comparison table.

In the step of managing an implementation of the SARPs, since all affairs are generally carried out by a manual operation (S_old4) in which the operator utilizes the documents or the files, there are problems in that a process of performing the affair is ill-defined and it is very difficult to clarify where the responsibility lies in a case that any mistake is generated since there will be a strong possibility of generating the human error in a process of documentation for the state letter, the safety regulation and the aviation statute. However, once the SMIS system according to the present invention is utilized, the department in charge and the person in charge (that is, a staff in charge, an identifier and a deciding officer) are surely updated in real-time (S_new4), and so there is no margin for error and although the problems are generated, the stored information is rapidly searched so that it is possible to know clearly the step at which the error is generated. Accordingly, it is possible to clarify where the responsibility lies and the efficiency of affair is rapidly increased.

Also, in the step of analyzing/reporting/assessing the task result, since all affairs are generally carried out by a manual operation and the substantial same affairs are repeatedly performed (S_old5), like other steps, too much man power and time should be required for performing the affairs. However, once the SMIS system according to the present invention is utilized, the analysis/report/assessment program (7) monitors in real-time on the basis of the implementation management database (5) (S_new5), and so the systematic and efficient task analyzing results can be obtained.

One example of the operation flow of the SMIS system according to the present invention is described as follow. For example, in a case where the state letter regarding a revised proposal of the clause 1.1 of the ICAO Annex 1 is received, the information of a title of the state letter, an issue date, a distribution date, a department in charge, a person in charge, an acting plan and a document file received or filed are stored in the tables of Table_SL, Table_SL_Charge, Table_SL_Rule, Table_SL_File_Attach, Table_SL_File_Reply as shown in FIG. 1, respectively. Then if the clause 1.1 of the Annex 1 is officially proposed, the number of the annex, the regulation number, a content of the regulation and the latest revised information are stored in the tables of Table_Annex and Table_Version, respectively. The domestic regulation regarding an implementation of the requirement of the clause 1.1 of the Annex 1 is inputted to the table of Table_Kor_Rule and the comparison/analysis result for the clause 1.1 of the Annex 1 and the domestic regulation is inputted to the table of Table_Annex_Rule. According to the comparison/analysis result, the department in charge, the person in charge, the date on which a completion of the measure is requested, the measure schedule, the reason for delaying (when there is a relevant data) and the display showing a termination of acting plan are inputted to the tables of Table_Annex_Charge and Table_Charge, respectively.

FIG. 5 is a view showing an example of the matrix for verifying an implementation status of the international regulation. As indicated in the table as shown in FIG. 5, the ICAO regulation and the domestic regulation are compared with each other and the information on the difference between the regulations is classified and entered into the database. For example, the domestic regulation judged as “Reinforce the regulation” means that the domestic regulation is managed in a state the ICAO regulation is more reinforced, and the domestic regulation judged as “There is no regulation” means that there is no corresponding regulation in own country so that there is need to revise the domestic regulation. After the information classified as described above is entered into the database, this data is taken out at any time by the comparison/management program (6) and the analysis/report/assessment program (7) and the required information is processed according to the item and the required category thereof and can be valuably utilized.

The comparison/management program (6) classifies all the inputted data into “Excellence”, “Insufficiency”, “Similarity”, “Less protective or partially compliance” and “Not applicable” and processes the data into the data in the form of a graph or a table such as the entire items status, the entire difference status, a difference-less protective or partially compliance status and Not applicable, and then provides the user with the processed data. FIG. 5 shows one example of the form of the data processed and provided by the comparison/management program (6).

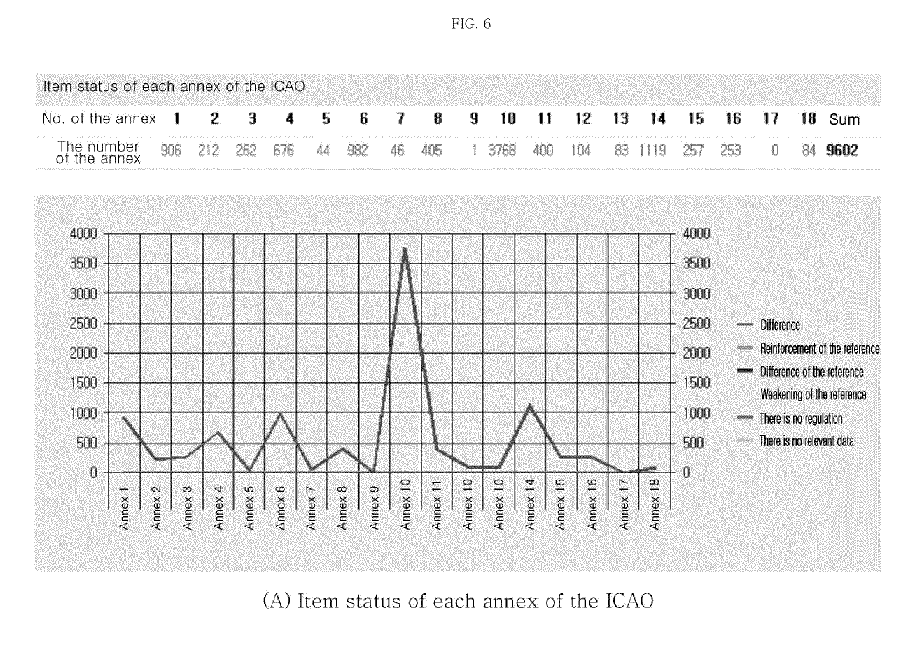

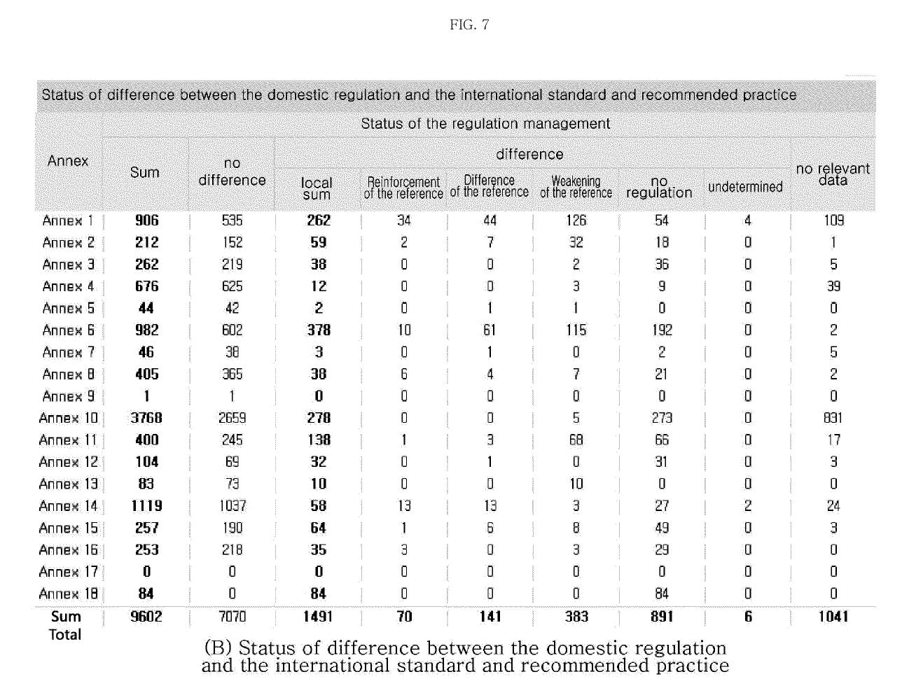

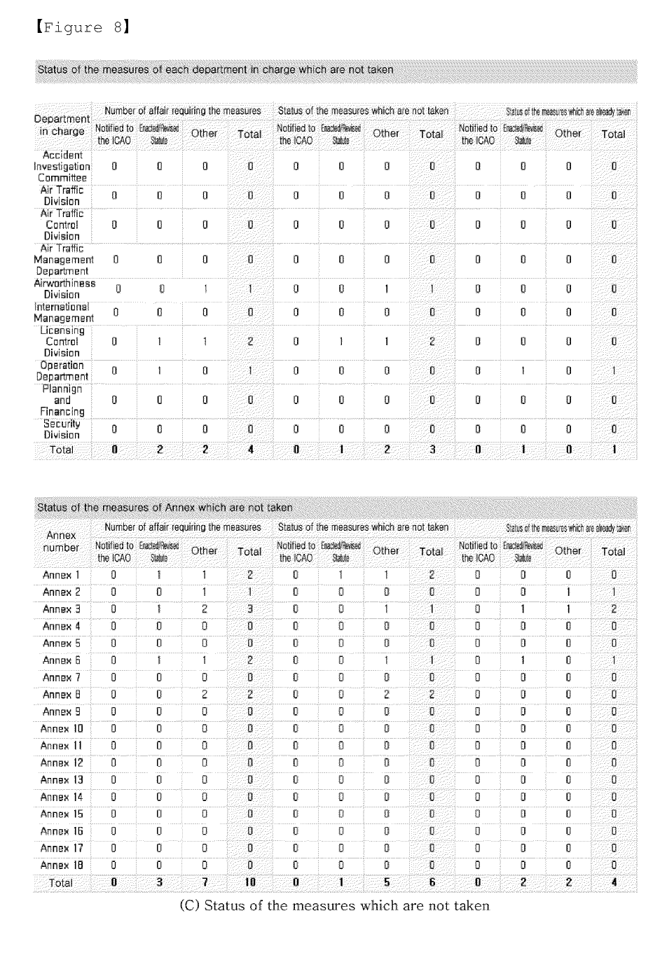

FIG. 6, FIG. 7 and FIG. 8 are views showing operation examples of the analysis/report/assessment program. The analysis/report/assessment program (7) processes the analyzing results of the entire data according to a request of the user, various purposes and requirements such as a difference status between the domestic regulation and the SARPs, a difference status of each department in charge, a transition of the difference, an examining result status, a status of items requiring the measure, a status of items requiring the measure-pending item/a delaying status/a list of pending items/a list of delayed items, a status of the enactment/revision of the statute and the like, and then provides the user with the processed data as the report. FIG. 6a shown the item status of each ICAO annex, the item status can be printed in the form of a table or a graph as shown in the drawing. The user sees a screen on which the data processed by the analysis/report/assessment program (7) is displayed as shown in FIG. 6 and can know at a glance the status such as the number of the items according to No. of the annexes or a difference between the domestic regulation and the SARPs, a reinforcement of the reference. FIG. 7 shows an example in which a difference between the domestic regulation and the SARPs is printed in the form of the table. FIG. 7 shows that the analysis/report/assessment program (7) outputs the data in the form of the table, as known from the drawing, the data can be printed in the form of a graph shown at a lower side in FIG. 6. As described above, the analysis/report/assessment program (7) processes the information stored in the database by the means of various methods and then outputs the processed data, and so the user can rapidly and easily output, retrieve and lookup the desired information. FIG. 8 shows an example in which a status of pending items which require the measures is shown, the user can grasp at a glance the status of pending items which require the measures through the analysis/report/assessment program (7). Also, if any one of the pending items is conducted, the person in charge who has conducted the corresponding item updates this information through the terminal (30) as shown in FIG. 2 in real-time. For example, in a state that the number of item in the status of pending items which require the measures in Annex6_The Others is 1 (one), once the person in charge conducts the corresponding item to complete the measure, the person in charge updates that the measures for the corresponding item is completed. Accordingly, the number of item in the status of pending items which require the measures in the table of Annex6_The Others of FIG. 8 is changed from 1 (one) to 0 (zero), and the number of item in the status of conducted items in the table of Annex6_The Others is changed from 0 (zero) to 1 (one), and so the user verifies the status of pending items in real-time. According to the prior art, since such affairs is generally performed by a manual operation using the documents, it is impossible to grasp immediately the status although the person in charge reports a completion of the measure. However, according to the analysis/report/assessment program (7), an understanding of such can be easily and rapidly achieved.

The present invention is not limited to the embodiment as described above, and those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

The present invention as described above compares and analyzes a difference between the aviation statute and the SARPs, enters the related data into the database using the information technology such that the implementation status is managed in real-time to take the proper measures and automates a series of affair analyzing/conducting processes. Accordingly, according to the present invention, there is an effect in that the comparing/analyzing processes for the SARPs which are generally and repeatedly managed by a manual operation are automated. In addition, the present invention has an effect in that the drawbacks such as an increase of the required time, a lower of process efficiency of the man power and a waste of expenses caused by a manual operation are radically removed so that all the resource can be effectively utilized.

Also, since the present invention has the universal concept such that the present invention is applicable to every member nation of the International Civil Aviation Organization, the system of the present invention can be applied in any country if the aviation statutes are entered into the database, and so the utilizing efficiency is maximized. In addition, the present invention can be introduced and applied to the international aviation society due to the above advantages so that there is the large ripple effect which can improve remarkably an aviation field of own country in the international aviation society.

1. A SMIS system, comprising:
a database server (10) including a state letter database 1 consisting of the information on state letters regarding a proposal for enacting/revising the SARPs; a safety regulation database (2) consisting of the information on the SARPs; an aviation statute database (3) consisting of the information on the aviation statute of own country; a comparison/analysis database (4) consisting of the comparison/analysis information on the aviation statute of own country and the SARPs; and an implementation management database (5) consisting of the information on the implementation status;
a main server (20) including a comparison/management program (6) connected to the database server (10) and comparing/analyzing the information of the safety regulation database (2) and the information of the aviation statute database (3) and arranging/processing the comparing and analyzing results and then updating the results to the comparison/analysis database (4); and an analysis/report/assessment program (7) providing the information processed by the comparison/management program (6) and receiving the information on an implementation status to update the information to the implementation management database (5); and
a terminal (30) connected to the main server (20) via a cable network or a wireless network to transfer the information on the implementation status to the main server (20) and retrieving, lookuping, amending, saving or deleting the information stored in the database server (10) through the main server (20).

2. The SMIS system as set forth in claim 1, wherein the state letter database 1 comprises the information including a title, a number, an issue date, a distribution date, an essential content, an item indicating whether the state letter issued previously is existed or not and the number of the related annex.

3. The SMIS system as set forth in claim 1, wherein the safety regulation database (2) comprises the information including the number of annex, the latest revised information, the number of regulation, a content of the regulation and an item indicating whether the duty is implemented or not.

4. The SMIS system as set forth in claim 1, wherein the aviation statute database (3) comprises the information including a title of the statute, the number of the statute, a date on which the statute is enacted/revised, the number of the enacted/revised statute, the number of each article of the statute and a detailed content of the article.

5. The SMIS system as set forth in claim 1, wherein the comparison/analysis database (4) comprises the information classified into five (5) items of “Excellence” indicating “More exacting or exceeds”, “Similarity” indicating “Different in character or other means of compliance”, “Insufficiency” indicating “Less protective or partially compliance”, “Not implemented” indicating “Insufficient at all” and “Not applicable” indicating that “not applied to own country”.

6. The SMIS system as set forth in claim 1, wherein the implementation management database (5) comprises the information including a department in charge, a person in charge, a date on which a completion of the measure is requested, an acting plan, a reason for delaying and a display showing a termination of acting plan.

7. The SMIS system as set forth in claim 6, the information on the person in charge is classified into the information of a staff in charge, an identifier and a deciding officer.

8. The SMIS system as set forth in claim 1, wherein the terminal 30 comprises a personal computer, a notebook computer, a personal digital assistant, a cellular phone and a private terminal.
